(19) United States
(12) Patent Application Publication
(10) Pub. No.: US 2026/0296929 A1
(43) Pub. Date: Oct. 1, 2026

(54) ACOUSTIC RESONANCE AND TOROIDAL VORTEX SYSTEM FOR WATER SANITATION, FLUID PURIFICATION, AND ATMOSPHERIC MOISTURE HARVESTING

(71) Applicant: Jacob Warren OWENS, Cape Girardeau, MO (US)

(72) Inventor: Jacob Warren OWENS, Cape Girardeau, MO (US)

(21) Appl. No.: 19/434,364

(22) Filed: Dec. 29, 2025

Related U.S. Application Data
(60) Provisional application No. 63/781,443, filed on Apr. 1, 2025.

(51) Int. Cl. C02F 1/36; C02F 103/02

(52) U.S. Cl. CPC C02F 1/36; C02F 2103/02; C02F 2201/002; C02F 2201/008

(57) ABSTRACT

According to one or more embodiments systems and method for non-chemical fluid sanitation may be provided. In an exemplary embodiment A system may include one or more acoustic transducers that emit modulated sound frequencies between 20 Hz and 3 MHz into a fluid medium, a vortex-generating structure may induce toroidal or spiral flow within said fluid, and a programmable control module may vary frequency, amplitude, and pulse characteristics to induce acoustic cavitation, resonance entrainment, and microbial disintegration.

### CROSS-REFERENCE TO RELATED APPLICATIONS

This application claims benefit to U.S. Provisional Application No. 63/781,443, filed Apr.1, 2025, titled “Acoustic Modulation Device for Medical Applications and Method Thereof,” by the same inventor, Jacob Warren Owens. The entire contents of the parent application are hereby incorporated by reference in their entirety.

### BACKGROUND

Access to clean water remains one of the most pressing and persistent global challenges. According to the World Health Organization (WHO), over two billion people currently lack access to safely managed drinking water services. Conventional water treatment methods including chlorination, ozonation, ultraviolet (UV) irradiation, and filtration are chemically or mechanically intensive, dependent on centralized infrastructure, and vulnerable to breakdowns in power, logistics, or supply chains. In rural, disaster-stricken, off-grid, or resource-limited environments, these dependencies render traditional sanitation strategies unreliable or entirely inaccessible.

Furthermore, the emergence of biofilm-resilient microbial species, antibiotic-resistant bacteria, and persistent organic pollutants has diminished the effectiveness of many standard disinfection approaches. Chemical sanitation methods, such as chlorine and iodine treatment, often leave toxic byproducts or fail to penetrate microbial biofilms. Membrane filtration systems clog over time and require replacement components and pressure gradients. UV-based systems are energy-intensive, easily fouled by turbidity, and offer no structural reorganization of water at the molecular level. These technologies treat the symptoms of contamination but fail to address water's structural or energetic integrity.

In addition to sanitation, water scarcity continues to escalate. Desertification, population growth, infrastructure collapse, and climate volatility have led to widespread water stress. In many regions, surface water and groundwater sources are unavailable or unsafe, while rainwater is intermittent and frequently contaminated. Traditional atmospheric water harvesting methods, such as refrigeration-based condensers or chemical desiccants, require significant energy input and offer limited scalability in low-resource contexts. Existing systems focus on extracting water from air without consideration for purification or molecular restructuring.

### SUMMARY

According to one or more embodiments systems and method for non-chemical fluid sanitation may be provided. In an exemplary embodiment A system may include one or more acoustic transducers that emit modulated sound frequencies between 20 Hz and 3 MHz into a fluid medium, a vortex-generating structure may induce toroidal or spiral flow within said fluid, and a programmable control module may vary frequency, amplitude, and pulse characteristics to induce acoustic cavitation, resonance entrainment, and microbial disintegration.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 shows a perspective view of an acoustic modulation ring device according to an exemplary embodiment of the invention.

FIG. 2 shows a lateral view of a toroidal vortex sanitation chamber according to an exemplary embodiment of the invention.

FIG. 3 shows an atmospheric water harvesting configuration according to an exemplary embodiment of the invention.

FIG. 4 shows a dodecahedron coronal view of a coherent water structuring chamber with toroidal flow according to an exemplary embodiment of the invention.

FIG. 5 shows a flow diagram of a smart sensor and AI feedback integration system according to an exemplary embodiment of the invention.

FIG. 6 shows an exemplary portable, field-deployable embodiment of the invention.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

Many of the embodiments described herein are described in terms of sequences of actions to be performed by, for example, an Artificial Intelligence (AI) module or modules. It will be understood by those skilled in the art that the sequence of actions described herein can be embodied entirely within any form of AI or ML architecture such that execution of the sequence of actions enables the processor to perform the functionality described herein. Thus, the various aspects of the present invention may be embodied in a number of different forms, all of which have been contemplated to be within the scope of the claimed subject matter. For example, machine learning architectures include but are not limited to Artificial Neural Networks (ANNs), Multi-Layer-Perceptrons (MLPs), Support Vector Machines (SVMs), Recurrent Neural Networks (RNNs), Convolutional Neural Networks (CNNs), Large Language Models (LLMs), transformers, decision trees, random forests, gradient boosting, nearest neighbor models, clustering algorithms, expert systems, mixture of experts models, ensemble models, diffusion models, reinforcement learning, and autoencoder models, to name a few. However, many other forms of AI and ML architectures that enable the processor to perform the same functionality have been considered. The foregoing architectures are exemplary and non-limiting, and any algorithmic or computational control logic capable of performing the described functions may be employed.

It may generally be contemplated for any AI or machine learning architecture to be retrained according to the data processed herein, for example automatically or continuously retrained on a predetermined schedule or based on one or more triggers, such as based on one or more detected changes in the data.

It may be contemplated for execution of the sequence of actions contemplated to be undertaken by the AI or ML architecture to be based on data retrieved from any sensor contemplated herein, and for execution of the sequence of actions to include actuation of any of the one or more transducers contemplated herein.

In one or more exemplary embodiments an acoustic resonance and toroidal vortex system may be provided.

According to one or more embodiments a programmable, non-chemical system for the purification, restructuring, and harvesting of water and other fluids using structured acoustic resonance and toroidal vortex dynamics may be provided. In some embodiments the system may operate through the integration of harmonically modulated sound fields, geometric field amplifiers, vortex flow architecture, and sensor-driven feedback control. It may eliminate microbial contamination, dismantle biofilms, enhance the molecular coherence of water, and extract atmospheric moisture without the use of chemicals, filters, or refrigeration-based condensation systems.

The system may include the following components: (1) one or more acoustic transducers capable of emitting frequency-modulated waveforms in the range of 20 Hz to 3 MHz; (2) a vortex-generating fluid chamber configured to induce toroidal flow, enhance acoustic cavitation, and prevent stagnation; (3) an acoustic condensation zone configured to extract water from ambient air using pulsed pressure fields; (4) an optional geometry-informed amplification structure, which may include one or more resonant, harmonic, or symmetry-based geometric configurations, including but not limited to toroidal, lotus, dodecahedral, spiral, polyhedral, fractal, or other field-structuring geometries to support resonance symmetry and waveform coherence; (5) a smart sensor array linked to a control module that modulates waveform output based on real-time fluidic and environmental data.

In one exemplary embodiment, the system may be configured as a portable water purification system capable of receiving contaminated water, subjecting it to multi-frequency acoustic cavitation within a vortex chamber, and outputting sanitized, structured water without requiring chemical treatment, pressurization, or membrane filtration. In another embodiment, the system is configured for atmospheric water harvesting, wherein ambient air is guided through an acoustic nucleation field that condenses water vapor into liquid form. In both embodiments, water may be passed through a final structuring zone using pulsed resonance—optionally including frequencies such as 605 Hz and other harmonic, subharmonic, or biologically relevant frequencies —to optimize molecular coherence and bioavailability.

The system may be fully scalable and may be implemented as a hand-held field unit, a wall-mounted atmospheric generator, or a multi-channel purification device for clinical, agricultural, or humanitarian applications. It may be powered by solar panels, rechargeable batteries, kinetic input, or external electrical sources. The design supports modular deployment, enabling field teams or off-grid communities to assemble multiple units based on need, water source, or ambient humidity.

Some embodiments of the invention may further support autonomous operation through sensor feedback. Embedded temperature, flow, microbial, and impedance sensors may monitor real-time input and trigger adaptive waveform modulation through the control module. This may allow the system to continuously optimize cavitation intensity, entrainment stability, and condensation rate without requiring external calibration or manual input.

By combining microbial sanitation, flow structuring, coherent water enhancement, and atmospheric moisture extraction into a unified platform, some embodiments of the invention may introduce a new class of intelligent, non-invasive water technologies. The architecture may support deployment in disaster response zones, medical facilities, wilderness settings, extraterrestrial habitats, and regions with no access to safe water or chemical supplies.

Some embodiments of the invention may introduce several key advantages over conventional water purification, atmospheric harvesting, and fluid structuring technologies. By unifying programmable acoustic modulation, toroidal flow geometry, and adaptive feedback control into a single system architecture, these embodiments address longstanding limitations in energy consumption, chemical dependence, scalability, and infrastructure requirements.

Unlike chlorination, ozonation, or iodine-based sanitation systems, the system may achieve microbial deactivation and biofilm disintegration through non-chemical acoustic resonance and cavitation. No toxic byproducts are formed, and no chemical reagents are required for ongoing use. This enables safe operation in sensitive medical, humanitarian, and ecological contexts.

Standard filtration and UV-based systems are generally ineffective against mature biofilms, which are resistant to chemical penetration and light exposure. Exemplary embodiments may utilize cavitation-driven shear forces and vortex-enhanced turbulence to physically dismantle biofilms and destroy encapsulated pathogens, including viruses, bacteria, and fungi.

Membrane-based filtration systems are prone to clogging and require sustained pressure differentials, limiting their use in off-grid or low-resource environments. Exemplary embodiments may use acoustic streaming and entrainment to sanitize and structure fluids without mechanical filters, reducing maintenance, energy draw, and component wear.

Conventional atmospheric water generators (AWGs) rely on energy-intensive refrigeration cycles or chemical desiccants. Exemplary embodiments may induce condensation through acoustic nucleation, enabling droplet formation without compressors, refrigerants, or sorbent regeneration. This dramatically lowers power requirements and increases field deployability.

No known sanitation or harvesting systems include molecular restructuring or coherent hydrogen bond alignment as a post-treatment step. Exemplary embodiments may use geometry-stabilized acoustic fields (e.g., lotus, dodecahedron, and other resonant geometric configurations) and coherence-promoting frequencies (e.g., 528 Hz, 605 Hz, and other biologically relevant frequencies) to generate biologically favorable water with improved absorption and energetic resonance properties.

Most existing water treatment systems operate using fixed-frequency settings or require manual recalibration. Some embodiments of the invention may incorporate real-time sensor input such as, for example, microbial load, impedance, temperature, and/or flow rate, into a closed-loop AI control system. Waveform frequency, amplitude, duty cycle, and sequence may be adjusted continuously for optimal performance.

Sanitation systems often suffer from stagnation zones, leading to uneven treatment. In some exemplary embodiments, the invention's toroidal chamber may maintain symmetrical, laminar vortex flow, ensuring complete and continuous exposure of the fluid to acoustic resonance fields. This also improves mixing, oxygenation, and structuring uniformity.

All embodiments may be powered via rechargeable battery, solar panel, kinetic crank, or USB input. This supports use in disaster zones, wilderness environments, developing regions, or extraterrestrial habitats without reliance on chemical resupply or grid infrastructure.

The system's modular components may allow adaptation to diverse contexts such as, for example, personal hydration, field surgery, community-scale sanitation, and/or IV fluid structuring.. The portable form factor and quick-connect modules enable rapid deployment and configuration in variable mission environments.

Unlike systems that require separate machines for purification, condensation, and structuring, the same embodiments of the present invention may integrate all three functions into a single, programmable platform. This reduces equipment cost, simplifies training, and ensures compatibility across use cases.

The use of symmetry-based geometric forms including torus, lotus, and dodecahedron may not only stabilize standing wave fields but also enhance resonance entrainment and coherence propagation. These geometries are absent from prior art yet are functionally critical to waveform organization and fluidic transformation.

In some embodiments, the system may use no chemicals, no aerosolization, and no high-voltage components. In such embodiments, it can thus be safely deployed in neonatal wards, burn units, isolation tents, mobile field hospitals, and planetary biospheres where traditional systems may be restricted or contraindicated.

In some embodiments, the invention may be industrially applicable across multiple sectors requiring decentralized, non-chemical, low-power water treatment, atmospheric harvesting, and fluid restructuring technologies. It is suitable for deployment in humanitarian, medical, agricultural, aerospace, residential, and disaster response environments.

The system may include a plurality of core components, such as, for example, piezoelectric or MEMS-based acoustic transducers, geometry-informed housing structures, AI-enabled control logic, and embedded sensor modules. These core components may be manufacturable using conventional microelectronics fabrication, injection-molded polymers, additive manufacturing (e.g., 3D printing), and commercial embedded systems platforms such as ESP32 and Bluetooth-enabled microcontrollers.

In some embodiments, the device architecture may be inherently modular and scalable. Portable units may be fabricated for individual hydration and clinical field use, while larger installations may be constructed for village-scale sanitation or spacecraft-based water recovery. Power requirements are minimal and compatible with existing renewable technologies including solar, kinetic crank, and USB recharging systems, enabling operation in grid-independent or infrastructure-compromised settings.

No consumables, filters, or chemical inputs may be required, reducing maintenance, resupply burden, and environmental impact. Materials used in fluid-contact components may include biocompatible, antimicrobial polymers compliant with international water safety and health standards. Acoustic waveform delivery and control protocols may be programmed via standard firmware interfaces or mobile-device-linked apps.

In some embodiments, the invention's manufacturability, safety, and utility across diverse use cases may establish its industrial applicability for mass production, cross-sector deployment, and integration into global water security, planetary resilience, and off-grid medical frameworks.

In some embodiments, the system may incorporate an AI-guided or algorithmically adaptive control architecture capable of real-time waveform analysis, pattern recognition, and signal output optimization. This control layer may enable dynamic modulation of frequency, waveform shape, amplitude, pulsing intervals, and spatial geometry based on sensor input, environmental feedback, or preprogrammed coherence protocols. The system may include a geometry-on-demand interface whereby resonant field structures (e.g., spirals, toroids, octahedrons) are generated or selected in response to biological, fluidic, or energetic parameters.

In addition, energy-harvesting subsystems may optionally be present to recapture vibrational or ambient energy for feedback or self-sustaining operation. This architecture allows for multimodal coherence induction across multiple systems simultaneously (e.g., electrical, fluidic, electromagnetic, quantum). Such configurations are optional and do not limit the fundamental scope of the invention.

In some embodiments, an AI system may be embedded within the device's control module or connected wirelessly to a distributed processing environment. It may receive continuous input from onboard sensors, including, for example, microbial load estimation via impedance, acoustic reflectivity, or bioelectrical signature, fluid temperature, turbulence, and flow rate, acoustic impedance shifts across the medium, condensation yield rate and ambient humidity resonance interference and cavitation event density. Based on these parameters, the AI module may dynamically adjust carrier frequency, harmonic structure, and waveform envelope, duty cycle and pulse modulation timing, transducer activation sequences, resonance symmetry and waveform coherence alignment, operating mode transitions (e.g., from sanitation to condensation).

In one exemplary embodiment, the AI system operates in closed-loop feedback, optimizing waveform profiles in real time to meet predefined thresholds for microbial reduction, coherence enhancement, or water output volume. These thresholds may be programmable, learned, or determined based on contextual mission priorities.

In another embodiment, machine learning models trained on historical sensor data, waveform efficacy logs, and environmental behavior may guide the predictive modulation of waveform profiles. These models may operate in, supervised learning mode (trained on outcome-labeled sanitation or structuring events), unsupervised clustering (to identify unknown contamination profiles or waveform anomalies), and/or reinforcement learning (using cavitation yield or resonance metrics as performance rewards).

In low-resource field deployments, AI may operate locally on microcontroller hardware with limited inference capability. In connected installations, AI logic may be enhanced by cloud-based synchronization, allowing aggregated environmental datasets to inform broader sanitation strategies across geographies.

In advanced modes, the AI subsystem may also select geometry overlays based on resonance feedback (e.g., activating a dodecahedral shell when impedance symmetry is low), trigger waveform rest cycles or resonance rebalance sequences based on acoustic fatigue detection, alert users to component degradation or sensor anomaly via wireless diagnostics, and/or log resonance fingerprint data for biologic fluid compatibility analysis (e.g., transfusion resonance match)

User-selectable AI operational modes may include Emergency Disinfection Mode utilizing maximum cavitation and waveform intensity for field trauma or contamination events, Coherent Hydration Mode emphasizing structuring frequencies (e.g., 528 Hz, 605 Hz) and geometric coherence, Atmospheric Harvest Mode, using condensation-tuned waveform pulsing to maximize vapor nucleation and/or Auto-Detection Mode, which may use fully autonomous waveform adaptation based on sensor data and environmental trends.

The system may include secure access protocols for firmware updates, AI model upgrades, and remote waveform profile uploads. In clinical or research settings, logged performance data can support regulatory validation, field deployment audits, or operational refinement across device fleets.

In sum, the integration of adaptive AI control transforms certain embodiments from a static sanitation tool into a dynamic fluid intelligence platform capable of learning, optimizing, and evolving its function across use cases, environments, and planetary domains. In some embodiments, the system is designed for flexible deployment across a wide spectrum of clinical environments, including field hospitals, ambulatory care, critical care units, low-resource clinics, and space-based life support systems. Its non-chemical, low-power, and intelligent architecture makes it uniquely suited to address clinical hydration, sterilization, and environmental fluid challenges where traditional infrastructure is unavailable or insufficient.

In mobile medical deployments responding to natural disasters, conflict zones, or pandemics, some embodiments may provide critical fluid sanitation and atmospheric water harvesting capabilities without the need for external power or chemical supply chains. Portable field units may be deployed within hours, producing clean, coherent water for wound irrigation, hydration, and intravenous preparation.

In high-acuity trauma settings, structured and coherent fluids may improve vascular absorption and reduce inflammatory complications. The system may sanitize and restructure crystalloid or colloid solutions on-site, optimizing hydration for septic, hemorrhagic, or vasodilated patients in time-sensitive contexts.

In underserved or geographically isolated areas, the device may serve as the sole means of producing potable water, sanitizing irrigation fluids, or structuring hydration for patients with chronic dehydration, gastrointestinal illness, or infection. Its autonomous functionality allows long-term use without chemical replenishment or skilled technician oversight.

In neonatal ICUs or pediatric wards, structured water may reduce metabolic stress and improve cellular hydration. The system's chemical-free, gentle acoustic processing supports use in sensitive patient populations, particularly where conventional sterilants may pose toxicity risks.

For patients receiving palliative, long-term, or home-based care, the system may provide accessible structured hydration and localized sanitation solutions. This is particularly relevant in immune-compromised individuals or in-home transfusion scenarios where IV fluid compatibility and purity are critical.

In closed-loop life support environments, such as spacecraft, underwater habitats, or high-altitude installations, the system may restructure recycled moisture, atmospheric vapor, or condensate fluid into coherent hydration with minimal energy expenditure. Structured hydration in altered gravity environments may support circulatory stability and neurophysiological adaptation.

Some exemplary embodiments may produce sterilized fluid without aerosolization or volatile compounds. It can be safely used in negative-pressure rooms, BSL-3/BSL-4 labs, or isolation tents to prepare decontaminated water for patient care or deactivation of contaminated biologic waste.

In some exemplary embodiments, deployment scenarios may include backpack-integrated personal field units for medics and relief workers, wall-mounted systems for clinics powered by battery or solar input, in-line modules inserted into preexisting IV, hydration, or sanitation lines, ambulance-integrated systems for mobile IV fluid structuring en route, modular community-level sanitation hubs for refugee or humanitarian camps, closed-loop water reconditioning systems for Mars, lunar, or orbital habitats, remote-monitorable installations with cloud-linked AI performance updates, and/or mobile trauma teams using preset AI modes for emergent decontamination.

By combining atmospheric harvesting, coherent water generation, and sensor-based acoustic sanitation in a single field-capable unit, some embodiments may introduce a scalable solution for life-saving fluid management wherever it is most urgently needed.

In some embodiments, the system may be used in a wide range of environments and operational domains, including, for example, water sanitation, atmospheric moisture harvesting, hydration fluid structuring, transfusion support, biological fluid compatibility assessment, and investigational applications involving resonance-based modulation of fluids for human use.

The system may be designed to function as a non-chemical, programmable, resonance-based platform capable of purifying, restructuring, and condensing fluids across clinical, humanitarian, environmental, and extraterrestrial settings. Its applications may include oral hydration preparation, wound irrigation sanitation, structured intravenous fluid support, biologic research, and atmospheric moisture capture.

Where the system is deployed for the purpose of hydration, wound irrigation, or general potable water purification, no special regulatory designation may necessarily be required beyond standard environmental sanitation certifications.

Device configurations may include administrative access restrictions, waveform security protocols, or credential-based control systems to ensure proper application in regulated environments.

In some embodiments, the system may include a light-emitting component (e.g., LED, laser diode, or other photonic emitter) as an optional output modality. This light component may be controlled by the same signal-generating architecture that modulates the acoustic and geometric outputs. While some embodiments primarily utilize sound-based resonance and structured geometry, a light-emitting module, if present, may serve one or more of the following purposes: (1) biofeedback signaling to indicate system state, coherence phase, or physiological resonance, (2) auxiliary therapeutic or diagnostic illumination based on targeted wavelength selection, or (3) visualization of real-time resonance fields. The light module, if integrated, may be static, pulsed, frequency-modulated, or AI-coordinated. The system is not limited to any specific light frequency or form, and the light component is optional and modular. The omission of such a module does not alter the core functionality of the invention.

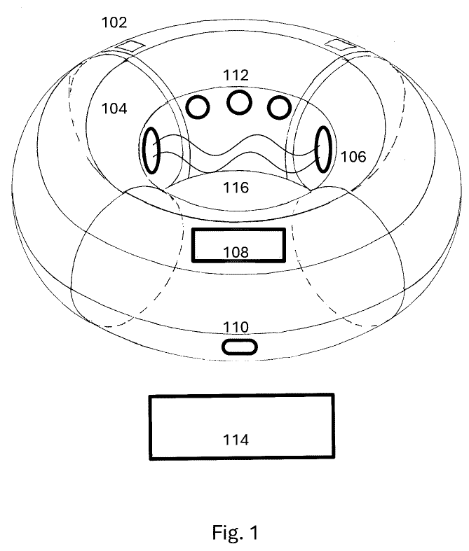

Turning to FIG. 1, an exemplary acoustic modulation ring device 100 may be provided. The acoustic modulation ring device 100 may include a hinged ring 102. In some embodiments, the hinged ring 102 may have a secure locking mechanism. The hinged ring 102 may include embedded dual frequency oscillators 104 and/or internal piezoelectric transducers 106. A programmable microcontroller 108 may drive the transducers and coordinate input from smart sensors 112. In some exemplary embodiments, the programmable microcontroller 108 may include wireless interface such as, for example, Bluetooth/ESP32. The smart sensors 112 may be configured to detect, for example, impedance, microbial load, temperature, flow rate, or other values. Power may be supplied by a modular rechargeable system 110 and/or a battery 114. In some embodiments, similar configurations may generate an acoustic streaming and micro-vibrational modulation field 116, which may form a foundational platform for subsequent embodiments including toroidal vortex sanitation, atmospheric harvesting, and coherent structuring chambers.

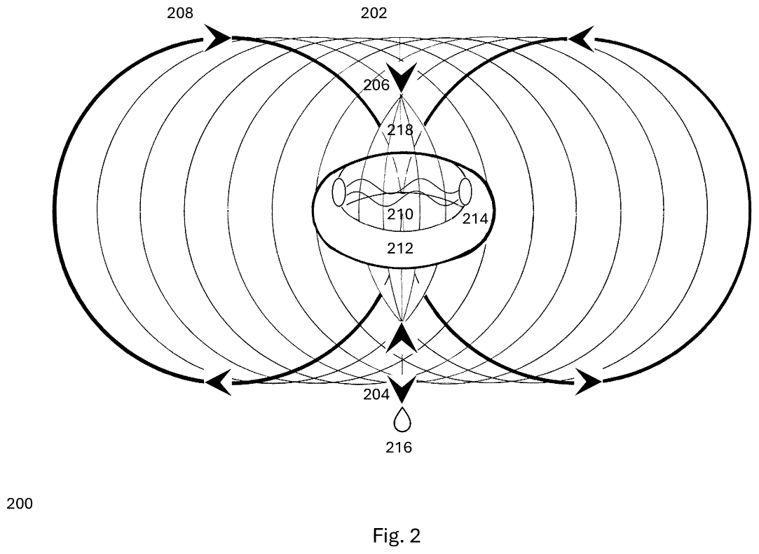

Turning to FIG. 2, a horn/spindle-torus vortex chamber 200 may be provided. The vortex chamber 200 may incorporate an acoustic modulation ring 212 at the torus waist. An upper axial inlet 202 may connect through a central axial channel 206 to a lower axial outlet 204. The central axial channel 206 may possess a longitudinal axis of symmetry. In some exemplary embodiments, the upper axial inlet 202 may serve as an entry point for fluid along the central axial channel 206.

Toroidal vortex flow paths 208, shown in FIG. 2 by directional arrows, may circulate fluid and converge at a cavitation focus 210. The toroidal vortex flow paths 208 may allow fluid to recirculate in loops around the torus body. In some embodiments, the cavitation focus 210 may serve as a high-energy interaction zone. Embedded transducer elements 214 within the modulation ring 212 may generate an acoustic streaming field 218, depicted schematically by a wavy symbol, which may induce microstreaming through the chamber. In some exemplary embodiments, embedded transducer elements 214 may be individual emitters within the ring. Processed fluid may exit at the lower outlet 204, which may condense into droplets 216.

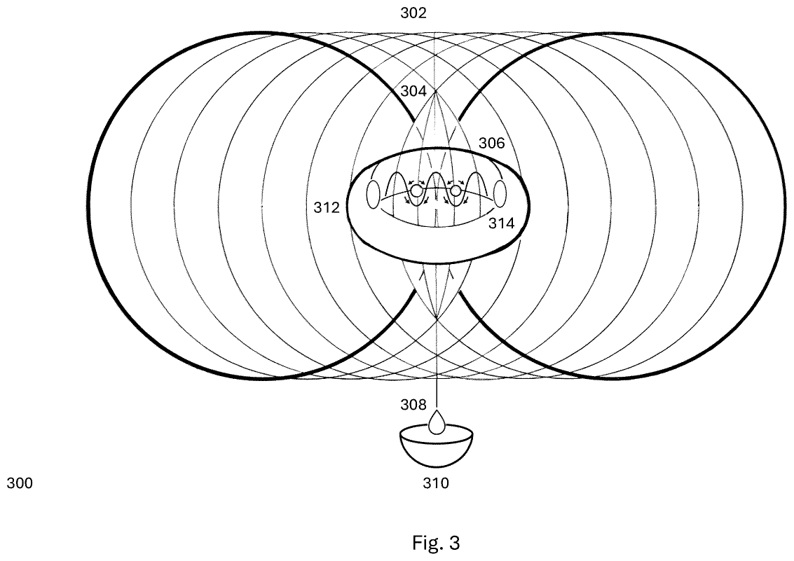

Turning to FIG. 3, an atmospheric water harvesting configuration 300 may be provided. Ambient air 302 may be directed into an acoustic resonance chamber 304, where a surrounding acoustic modulation ring 312 with embedded piezoelectric transducers 314 may emit pulsed, structured frequencies to generate condensation nucleation fields 306. These fields may promote droplet formation 308. Droplets may fall into a collection basin 310 for hydration or purification workflows. Similar configurations may enable efficient atmospheric water harvesting without refrigeration, filters, or chemical desiccants, making the system suitable for low-resource, disaster-relief, and/or extraterrestrial environments.

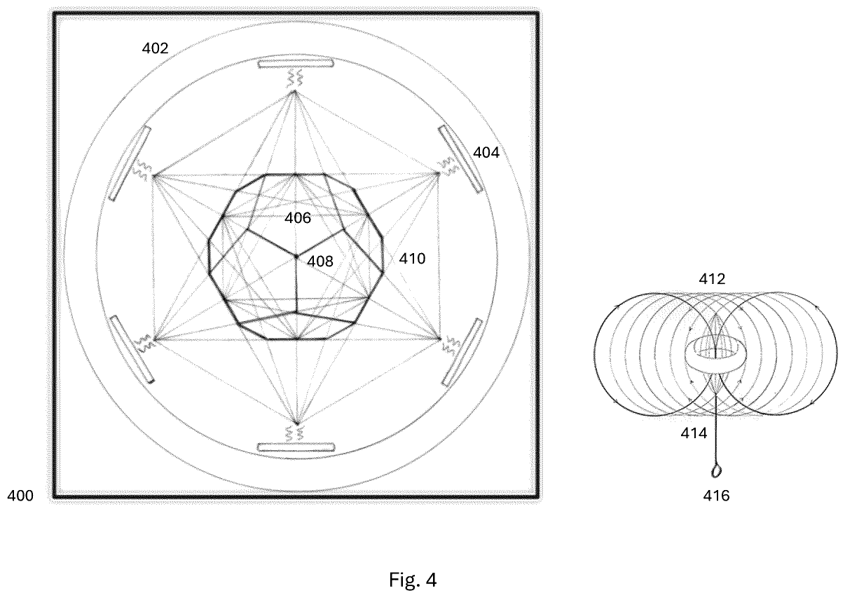

Turning to FIG. 4, a coherent water structuring chamber with toroidal flow may be shown. The water structuring chamber may include a portable housing 400, which may be a circular boundary enclosing the system. In some embodiments, the water structuring chamber may incorporate a dodecahedron resonance geometry. The geometric configuration may organize fluid flow toward a central convergence point (408), aligning hydrogen bonding networks and promoting molecular coherence.

The portable housing 400 may support an acoustic modulation ring 402 populated with piezoelectric transducers 404. The transducers may generate modulated acoustic fields into a structuring chamber 410 overlaid with dodecahedral symmetry in a dodecahedron field 406. Fluid may enter via an inlet port 412, be entrained through the resonance field, and exit via an outlet port 414. Structured water output 416 is shown schematically as a droplet. Toroidal energy flow paths 418 are depicted to represent internal circulation induced by resonance dynamics.

In some exemplary embodiments, the dodecahedron field 406 may amplify resonance stability, ensuring symmetry propagation and minimizing turbulent breakdown. In some embodiments acoustic fluid structuring may allow for hydration enhancement, biological compatibility, and sanitation applications.

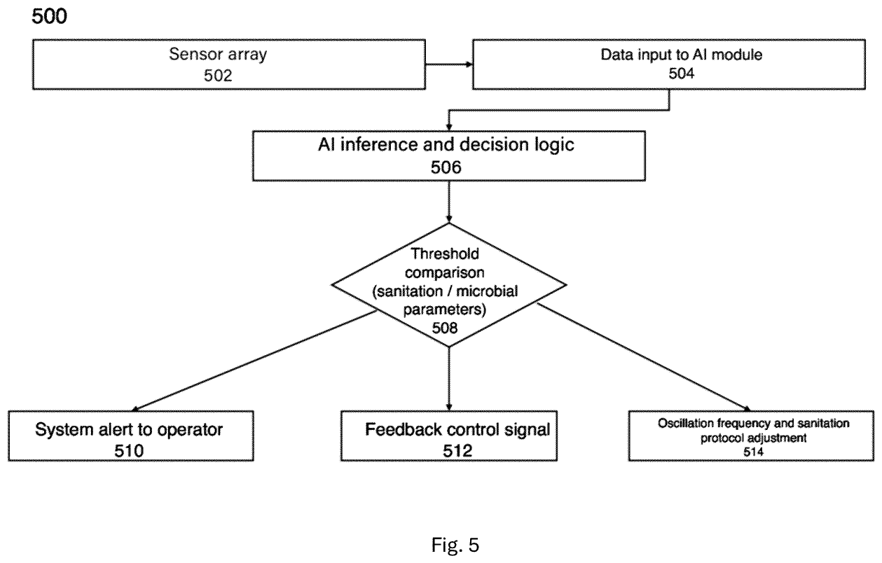

Turning to FIG. 5, a flow diagram of a smart sensor and AI feedback integration system 500 may be provided. In some embodiments, a sensor array 502 may collect, for example, microbial load, impedance, flow, temperature, and/or quality data and transmit it as input 504 to an AI module. The AI inference logic 506 may process the input using stored models and may compare the output against sanitation thresholds 508. If values exceed safe limits, the system may generate an operator alert 510 and issues feedback control signals 512 to adjust operational parameters. These adjustments may include oscillation frequency modulation, cavitation intensity modulation, and/or sanitation protocol changes 514, enabling adaptive optimization under varying conditions. In some embodiments, this closed-loop control may enable autonomous adaptation of the acoustic sanitation system without human intervention, allowing for robust operation in diverse environmental conditions.

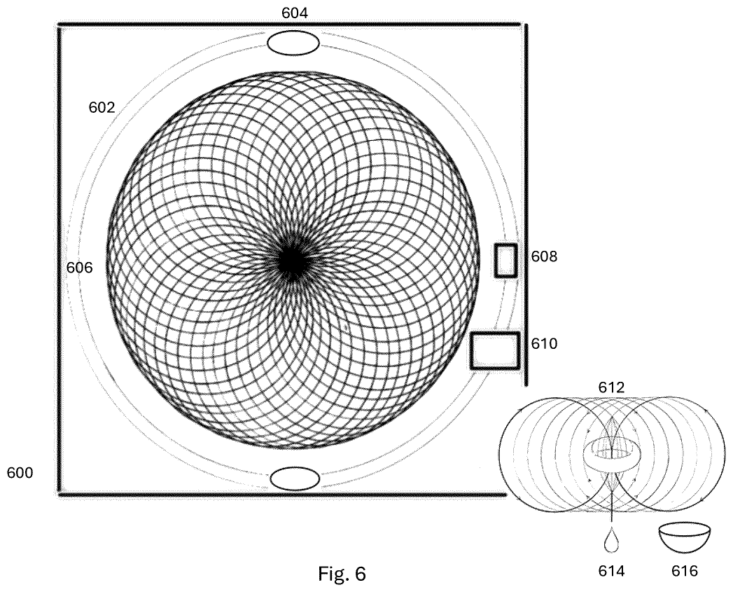

Turning to FIG. 6, an exemplary portable, field-deployable embodiment of the invention may be provided. This embodiment may include a portable housing 600. In some embodiments, the portable housing 600 may enclose an acoustic modulation ring 602 with piezoelectric transducers 604. Within the ring, a resonance or structuring chamber 606 may allow for acoustic fields to act upon air or fluid. This interaction may promote microbial sanitation, condensation, or molecular structuring, depending on the operational mode. In some embodiments, a control and power module 608 with battery or solar input 610 may drive the transducers. Fluid or air may enter through an inlet 612, be processed in the chamber 606, and exit through an outlet 614, optionally into a collection reservoir 616. The portable configuration may enable field deployment in humanitarian, medical, or off-grid environments without reliance on chemical consumables or refrigeration.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A non-chemical fluid sanitation system comprising:
one or more acoustic transducers configured to emit modulated sound frequencies between 20 Hz and 3 MHz into a fluid medium;
a vortex-generating structure configured to induce toroidal or spiral flow within said fluid; and
a programmable control module configured to vary frequency, amplitude, and pulse characteristics to induce acoustic cavitation, resonance entrainment, and microbial disintegration.

2. The system of claim 1, further comprising a geometric structuring chamber incorporating one or more geometries including, but not limited to, lotus, torus, dodecahedron, golden spiral, or other resonant, harmonic, or symmetry-based geometric configurations.

3. The system of claim 1, further comprising a sensor array configured to detect microbial load, pH, impedance, temperature, or flow rate.

4. The system of claim 3, wherein the sensor array communicates with an onboard AI module, the onboard AI module configured to adapt waveform modulation in real time.

5. The system of claim 1, wherein the emitted frequency includes one or more harmonic, subharmonic, or biologically relevant frequencies, including 605 Hz.

6. The system of claim 1, wherein the acoustic transducer is embedded within a toroidal or spiral housing.

7. The system of claim 1, wherein cavitation is enhanced using amplitude-modulated or harmonic pulse waveforms.

8. The system of claim 1, wherein the system is powered by at least one of solar, rechargeable battery, or kinetic energy input.

9. The system of claim 1, wherein the system is portable and operable without filters, chemicals, or refrigeration.

10. The system of claim 3, wherein coherence enhancement is achieved through resonance amplification within a dodecahedral acoustic shell.

11. A method for purifying and restructuring water, comprising:
transmitting a modulated acoustic signal into a fluid medium;
inducing toroidal or spiral flow within said medium;
disrupting microbial membranes and biofilms through cavitation; and
exposing the fluid medium to structured resonance frequencies to enhance hydrogen bonding, reduce surface tension, and improve biological coherence.
